(19) United States
(12) Patent Application Publication
(10) Pub. No.: US 2016/0121692 A1
(43) Pub. Date: May 5, 2016

(54) VENTILATION MODULE & ASSEMBLY WITH TWO STAGE INJECTION MOLDING FORMATION OF RIGID FRAME AND HINGEDLY ATTACHED FLAPS AND DIE/MOLD ASSEMBLY FOR CREATING THE VENTILATION MODULE

(71) Applicant: U.S. FARATHANE CORPORATION, AUBURN HILLS, MI (US)

(72) Inventor: Steve Porter, Romeo, MI (US)

(21) Appl. No.: 14/928,474

(22) Filed: Oct. 30, 2015

Related U.S. Application Data
(60) Provisional application No. 62/073,214, filed on Oct. 31, 2014.

(51) Int. Cl. B60H 1/24; B29C 45/00

(52) U.S. Cl. CPC B60H 1/249; B29C 45/0017; B60H 2001/3492

(57) ABSTRACT

A ventilation module and related mold assembly for producing, the module being integrated into a vehicle and including a housing defining an open interior which is adapted to secure to a location of the vehicle in order to communicate an exterior with a passenger compartment interior. A flap is hingedly secured along a selected edge in extending fashion across the open interior of the housing, the flap further including first and second side edges and an interconnecting top extending edge which are configured to engage support locations configured along the housing in proximity to the open interior. The flaps are configured to seal against the housing in a first direction to prevent the admittance or backflow of dirty air from the exterior into the interior compartment. The flaps open in a second direction in response to a positive air pressure condition created within the passenger compartment and in order to vent to the exterior the excess air pressure until reclosing upon achieving an air equilibrium condition.

### CROSS-REFERENCE TO RELATED APPLICATIONS

This Application claims the benefit of U.S. Provisional Application No. 62/073,214 filed on Oct. 31, 2014, the contents of which are incorporated herein in its entirety.

### FIELD OF THE INVENTION

The present invention relates generally to ventilation module for incorporating into a vehicle. More specifically, the present invention discloses a module which is mounted in communication with a vehicle panel in proximity to a trunk or other externally accessible location and is in communication with an interior passenger compartment.

The ventilation module includes any number of one way valve flaps supported within a main body or housing. A multi-component mold assembly is provided and utilizes a two shot injection molding operation for initially producing a rigid supporting frame and, subsequently, any number of softer flaps which are hingedly connected to inner and aperture defining edges of the frame.

The flaps are further configured to seal against the housing in a first direction to prevent the admittance or backflow of dirty air from the exterior into the interior compartment. The flaps open in a second direction in response to a positive air pressure condition created within the passenger compartment (such as resulting from the closing of a vehicle door) and in order to vent to the exterior the excess air pressure until reclosing upon achieving an air equilibrium condition.

### BACKGROUND OF THE INVENTION

The prior art is documented with examples of ventilation assemblies such as for use in relieving a positive interior pressure existing such as within a vehicle passenger compartment. Dietz, U.S. Pat. No. 6,132,308, discloses a method for making a forced ventilation apparatus for equalizing a pressure difference between a passenger compartment and surroundings of a motor vehicle. The apparatus includes a frame made of a hard plastic and delimiting an aperture, and a flat ventilation flap made of an elastomer material and secured to the frame. A resilient restoring force counteracts opening movement of the ventilation flap from a closed position in which the ventilation flap rests on the frame and closes the aperture in the frame.

A corresponding method includes injection molding the ventilation flap to the frame in an opened position. To this end, the elastomer material is pressed from a free end of the ventilation flap into a common contact area of the ventilation flap with the frame.

A further example is depicted in U.S. Pat. No. 8,328,609, to Schneider, and which discloses a back-air blocking device to ventilate a motor vehicle's inside space including a frame or housing made of a first plastic. Schneider also teaches a valve flap, made of a flexible material, is connected in one zone to the frame and in other zones resting against a sealing surface of the frame, when the flap is in its rest position, following which the flap detaches off the sealing surface when subjected to a pressure differential.

Other similar pressure relief vent designs include each of Valencia, Jr., U.S. Pat. No. 8,485,872, Weber, U.S. Pat. No. 8,419,513, Bloemeling et al., US 2009/0068940, Hayashi et al., U.S. Pat. No. 6,648,749, Omiya et al., U.S. Pat. No. 7,137,880, and Omiya et al., U.S. Pat. No. 6,837,784.

### SUMMARY OF THE INVENTION

The present invention discloses a ventilation module integrated into a vehicle, including a housing defining an open interior and which is adapted to secure to a location of the vehicle in order to communicate an exterior with a passenger compartment interior. A flap is hingedly secured along a selected edge in extending fashion across the open interior of the housing, the flap further including first and second side edges and an interconnecting top extending edge which are configured to engage support locations configured along the housing in proximity to the open interior.

The flaps are configured to seal against the housing in a first direction to prevent the admittance or backflow of dirty air from the exterior into the interior compartment. The flaps open in a second direction in response to a positive air pressure condition created within the passenger compartment and in order to vent to the exterior the excess air pressure until reclosing upon achieving an air equilibrium condition.

Additional features include the housing having a generally rectangular shape with an outer perimeter gasket which is secured to an outer perimeter projecting ledge and which defines a sealing surface for securing said housing to the vehicle. The housing further comprising a rigid first shot injection molded thermoplastic. The flaps further comprising a second shot softer injection molded plastic. The at least one flap can further be provided as a plurality of three valve flaps resistively engaged to the housing along bottom edges thereof and in order to seal first, second and third subset open interiors.

A related mold assembly is provided for producing a ventilation module and which includes a lower mold subassembly having a cavity configuration corresponding to an underside profile of a supporting tray or housing. An upper mold assembly includes a plurality of sub-components which are collectively seated upon the lower mold subassembly in a mold closing configuration, and in order to produce the tray in a first shot injection molding operation. Following this, at least one flap is formed in a second shot injection molding operation, in a fashion so that the extending direction of the flaps during their formation is generally upwardly/outwardly relative to the lower mold subassembly, and as so that the flaps are each hingedly secured along a selected edge in extending fashion across an open interior of the housing. This configuration also allows the steel mold forming surfaces associated with the molding operation and that is located on the backside of the flap to travel in the direction of the molding tool.

Additional features of the mold assembly include a subset plurality of the upper mold sub-components each further including a first upper mold sub-component exhibiting a smooth inner surface, an opposing mating surface of a second upper mold sub-component including an uppermost underside edge surface corresponding to an end of a second shot molded flap, a length extending surface and an inner/bottom-most curved surface. The second selected upper mold sub-component further includes an underside notch formed along a bottom most extending edge and which, in the closed position, seats a likewise width extending upper protuberance or nub associated with an interface location of the first shot formed tray and the lower supporting mold component.

The above arrangement prevents an undesirable flow through of second shot material and in order to prevent mis-forming of the flap configuration and to ensure that the concave profile created near a bottom edge of the flap and interfacing/molded over inner supporting surface of the tray provides for effective and long-life pivoting of the flaps between the open (exhaust) and closed (sealed positions). Yet additional features include an actuating mechanism including side supporting linkage arms associated with the upper mold assembly and for respectively coordinating timed closure and re-opening/release of the upper mold sub-portions relative the lower mold during the second shot formation of multiple softer material flaps.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an underside perspective of an outer rigid frame associated with the ventilation module and such as which can be produced in a first shot injection molding operation;

FIG. 2 is a rotated upper perspective illustrating the frame and a second shot/softer flap material which is injection molded in engaged fashion with inner aperture defining edges of the first shot frame;

FIG. 3 is an assembled view of a mold assembly, including upper and lower mold portions, for assembling the dual shot ventilation module;

FIG. 4 is a cutaway of the mold assembly illustrating the configuration of the lower mold half and the multiple upper mold half component;

FIG. 5 is a succeeding cutaway illustration showing upward retraction of a first sub-portion of the upper mold component associated with the injection molding formation of the second shot softer flap material;

FIG. 6 is a further succeeding cutaway illustration illustrating upward retraction of a further sub-portion of the upper mold component for fully revealing the hingedly secured and softer flap material;

FIG. 7 is a yet further succeeding cutaway illustration depicting the removal of the first shot frame or tray from the lower mold half;

FIG. 8 is a cutaway perspective similar to FIG. 4 and illustrating another variant of ventilation tray which includes three second shot injection molded flaps configured upon a first shot harder tray material defining an equal plurality of windows or openings over which the flaps seat in a closed position;

FIG. 9 is a succeeding cutaway illustration to FIG. 8 and depicting an alternate retraction protocol in which each of a plurality of first upper mold sub-portions are retracted following formation of each of the second shot softer flaps;

FIGS. 10-11 are a further succeeding cutaway illustrations in which each of a further plurality of second upper mold sub-portions are subsequently upwardly retracted to release and fully reveal the second shot flap, each of the second upper mold sub-portions further exhibiting a rounded detail extending along the bottom edge and for imparting a concave hinge profile to each flap proximate their joining locations with the first shot formed tray;

FIG. 12 is an environmental illustration in perspective of a ventilation tray created according to the present invention and which further illustrates the flap supporting features associated with the individual supporting inner frame locations; and

FIG. 13 is an illustration similar to FIG. 8 and illustrating a non-limiting example of an actuating mechanism associated with the upper mold assembly for coordinated closure and opening/release of the mold during the second shot formation of multiple softer material flaps.

### DETAILED DESCRIPTION OF THE PREFERRED EMBODIMENTS

As previously described, the present invention discloses a module which is mounted in communication with a vehicle panel in proximity to a trunk or other externally accessible location and is in communication with an interior passenger compartment. The ventilation module includes any number of one way valve flaps supported within a main body or housing. A multi-component mold assembly is provided and utilizes a two shot injection molding operation for initially producing a rigid supporting frame and, subsequently, any number of softer flaps which are hingedly connected to inner and aperture defining edges of the frame.

In one non-limiting application, the flaps are further configured to seal against the housing in a first direction to prevent the admittance or backflow of dirty air from the exterior into the interior compartment. The flaps open in a second direction in response to a positive air pressure condition created within the passenger compartment (such as resulting from the closing of a vehicle door) and in order to vent to the exterior the excess air pressure until reclosing upon achieving an air equilibrium condition.

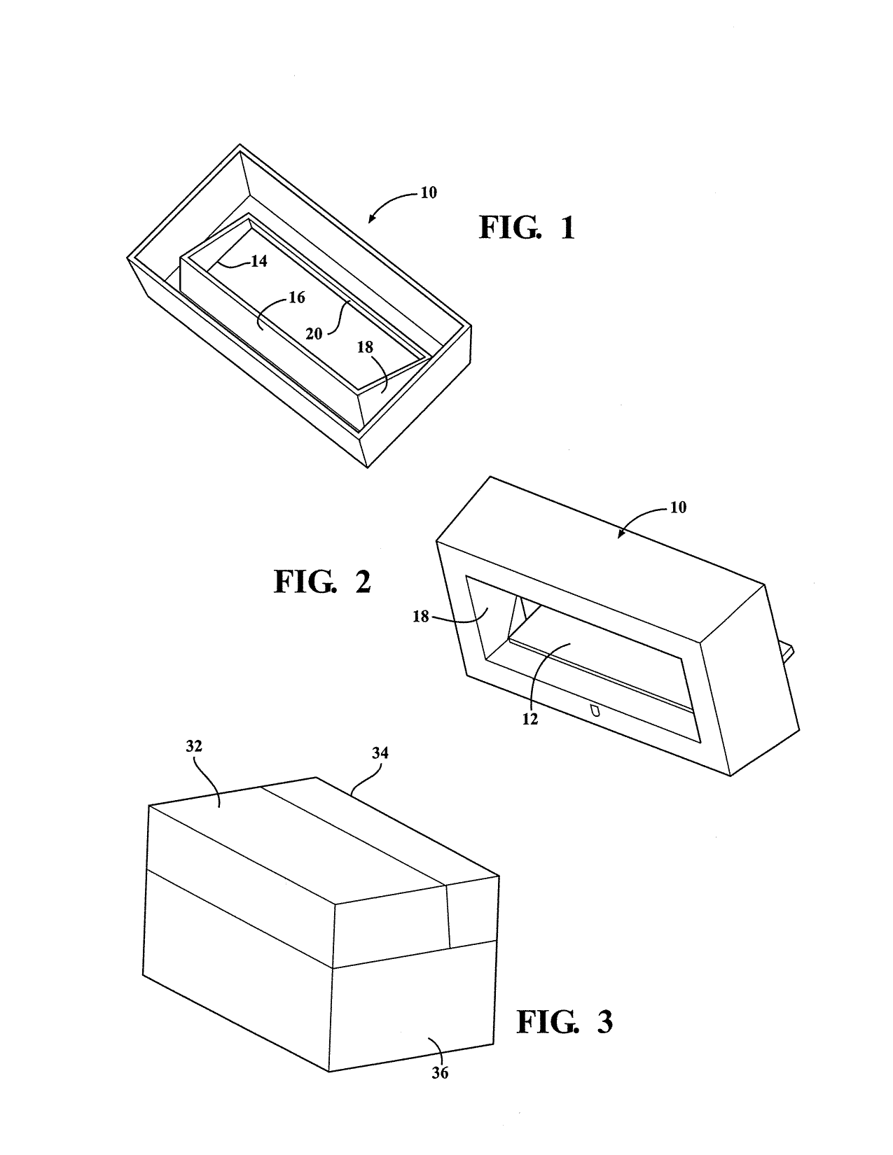

Referring now to FIG. 1, an underside perspective is generally shown at 10 of an outer rigid frame associated with the ventilation module and such as which can be produced in a first shot injection molding operation and such as will be described in further detail. The frame typically exhibits four sides with a generally rectangular shape and can include an inner three dimensional profile configured to support a deflectable and softer material second shot injection molded flap, this further depicted at 12 in FIG. 2.

The tray 10 as shown in FIG. 1 further includes a plurality of interior extending and interconnecting sides (see at 14, 16, 18 and 20) these defining upper support surfaces. The softer thermoplastic molded flap 12 is secured in extending fashion along selected side 20 (hidden in FIG. 2), such again occurring during a second shot injection molding operation for forming the inner pivotally supported flaps following the initial formation of the rigid outer tray structure.

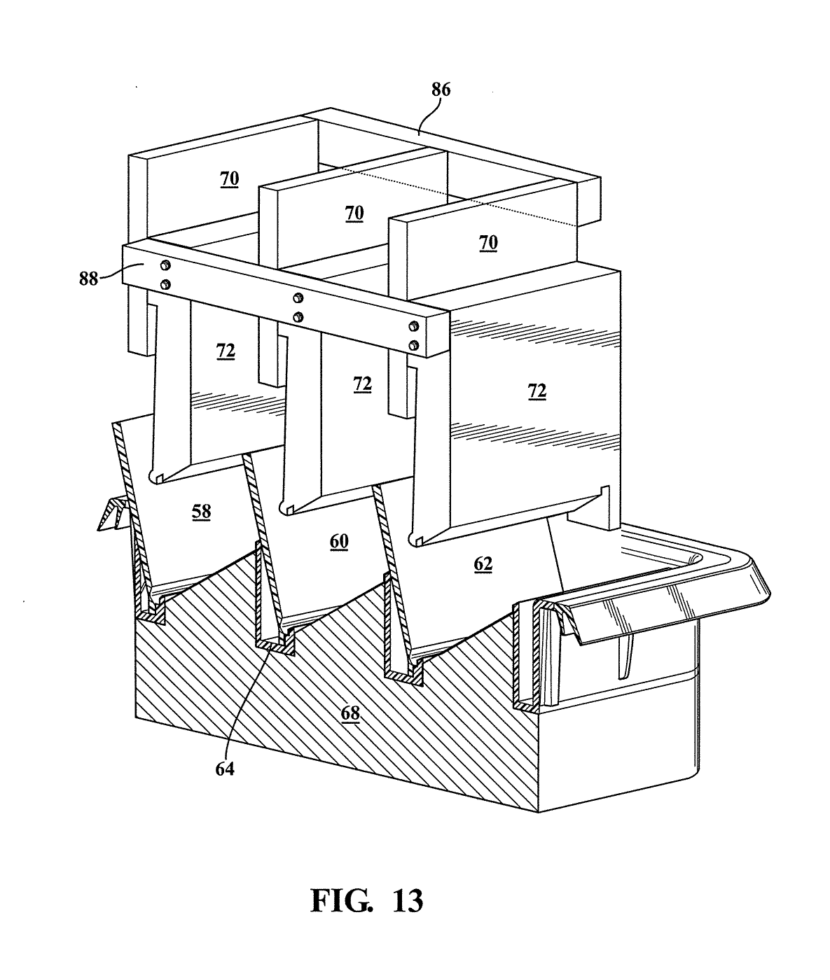

As further shown in the environmental illustration of FIG. 12, any variant of ventilation tray, such as incorporating a multiple plurality of (such as three) flexible flaps, can be created so that a bottom extending edge of each flap is hingedly secured along the tray support surface in a similar fashion. The support tray interior can further define any number of inner window or frame locations upon which seat the three interconnecting edges of each flap extending from the hingedly connected edge. This is further shown in FIG. 12 by selected intermediate revealed frame location defined by opposite ends 20 and 22, interconnecting sides 24 and 26 and intermediate bridging portion 28 (this further to prevent bowing deflection of a mid-portion of the associated flap 30 once it is hingedly secured along the selected side 24 and between the ends 20/22). Additional flaps 29 and 31 are also shown in FIG. 12 associated with upper and lower frame locations located on opposite sides of the intermediate frame location.

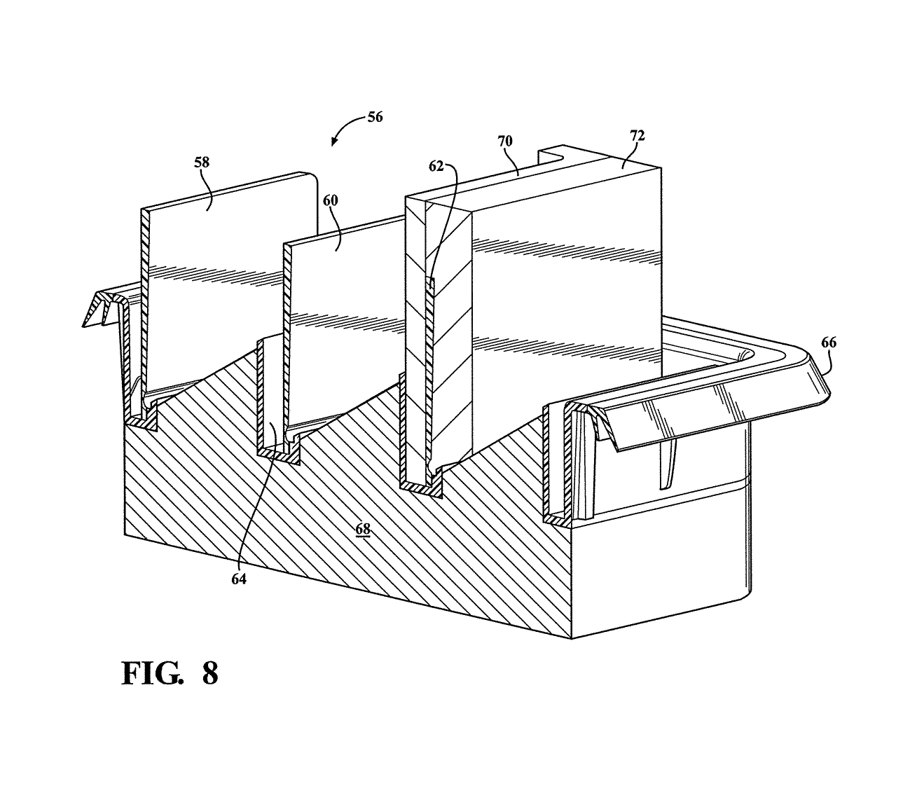

FIG. 3 is an assembled view of a mold assembly utilized in the production of the ventilation tray 10, such including upper 32/34 and lower 36 mold portions for assembling the dual shot ventilation module. The lower mold subassembly 36 exhibits an upwardly facing cavity configuration (see surfaces 38, 40, 42, et seq. as best seen in FIG. 7) corresponding to an underside profile of the supporting tray or housing 10.

As further shown, the upper mold assembly exhibits a plurality of sub-components, again at 32 and 34, which are collectively seated upon the lower mold subassembly in a closed mold configuration and in order to produce the tray 10 in a first shot injection molding operation, following which at least one flap 12 is formed in a second shot injection molding operation so that each flap is hingedly secured along a bottom edge in extending fashion across an open interior of said housing as previously shown in FIG. 2. Selected upper mold component 32 includes a collection of underside surfaces (44, 46, 48, et. seq. as shown in FIG. 6), with cooperating upper mold component 34 including a further collection of underside surfaces (50, 52, 54, et seq. as shown in FIG. 7) which, along with vertical extending edge 51 (FIGS. 5 and 7) associated with the upper assembleable mold component 34 which assembles against a rear angled surface 53 of the abutting mold defining component 32, cooperatively define the profile configuration of the tray upper surfaces and hingedly joined flap.

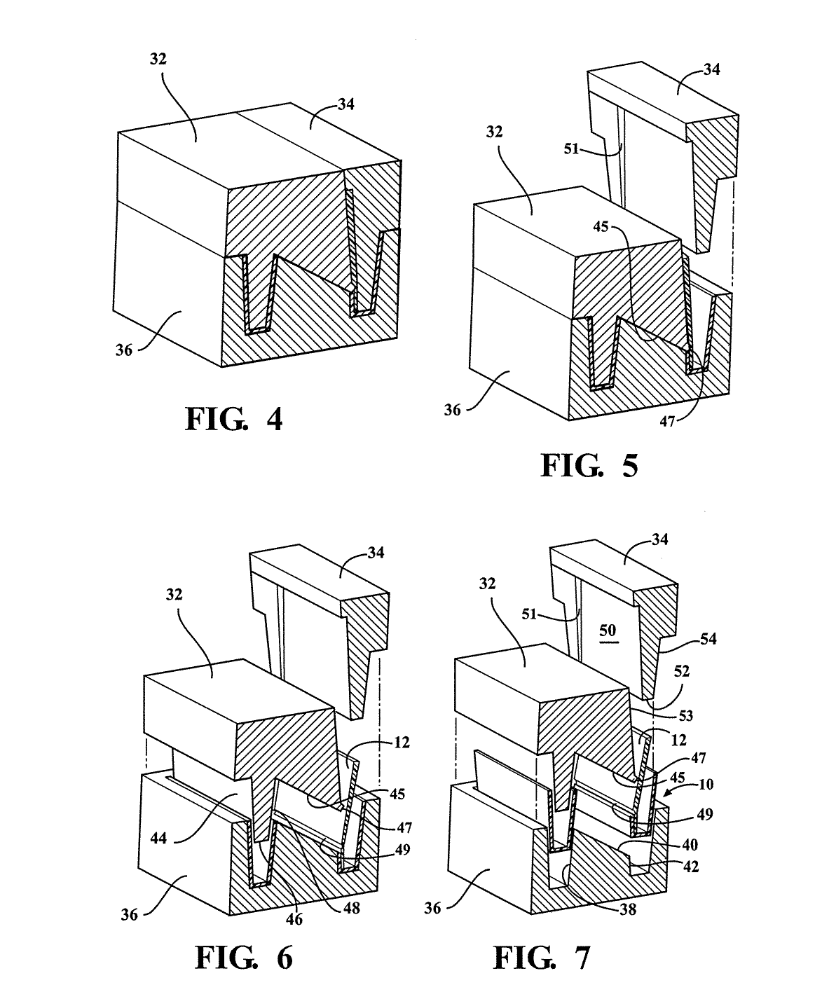

FIG. 4 further again depicts a cutaway of the upper mold components 32/34 seated upon the lower mold 36 in a closed mold defining fashion for creating a single flap module. At this point, a two shot injection molding operation is performed in order to introduce a first more rigid thermoplastic material to create the tray 10, following which a second subsequent injection molding of the flap 12 is performed and so that the flap is hingedly secured along an extending interior surface of the tray 10 (again FIG. 2) proximate the interior opening over which the flap is supported in the closed position.

As will be further disclosed with reference to succeeding variant FIGS. 8-11, the upper assembled mold portions 32 and 34 include structural details which, when assembled upon the lower base component 36, assist in forming the hinged location between the flap 12 and the first shot rigid tray 10. As best shown in FIGS. 6-7, this includes an angled underside surface 45 terminating in a lower projecting end detail 47 associated with selected upper assembleable mold portion 32 which extends away from interconnected underside defined surfaces 44, 46 and 48 associated with the first shot formation of the rigid tray 10. Upon assembling upon the lower mold portion 36 (see best again cutaway views of FIGS. 4-5) the projecting end detail 47 spatially locates close to opposing surface detail 50 of the second upper assembled portion 34 and, following the second injection molding operation, creates the hinged profile 49 (FIGS. 6 and 7), associated with the created flap.

While not shown, it is understood that a suitable two shot injection molding operation can include the provision of first and second heated thermoplastic materials which are initially provided in a molten form and which, upon being communicated by suitably configured channels to the negative profile established between the upper and lower closed mold components, successively create the harder tray 10 and softer flap 18 during the two shot operation.

FIG. 5 is again a succeeding cutaway illustration showing upward retraction of a first selected sub-portion 34 of the upper mold components associated with the injection molding formation of the second shot softer flap material 18 (this following again formation and sufficient cooling/curing of the flap during the second shot process). FIG. 6 is a further succeeding cutaway illustration illustrating upward retraction of the further sub-portion 32 of the upper mold component for fully revealing the hingedly secured and softer flap material 12, with FIG. 7 providing a yet further succeeding cutaway illustration depicting the removal of the first shot frame or tray 10 from the lower mold half 36 along with the hingedly formed flap 12.

Proceeding to FIG. 8, a cutaway perspective similar to FIG. 4 is generally shown at 56 and illustrates another variant of mold assembly and associated module produced thereby. A ventilation tray is shown which includes a plurality (e.g. three in the depicted embodiment) of second shot injection molded flaps, at 58, 60 and 62, configured upon a first shot harder tray 64 defining an equal plurality of windows or openings over which the flaps seat in a closed position. The tray 64 can also exhibit a trimmed outer edge 66 (see also inner spaced lip 67) or any suitable profile associated with the interior cavity defining configuration of the assembleable mold components (such as shown in FIGS. 4 et seq.) and further given the desired installation application, and the present invention further contemplates any number or configuration of flaps associated with the supporting tray of the ventilation module not limited to that depicted herein.

Similar to that shown in FIGS. 3-7, a variant of the mold assembly can include a single lower cavity defining mold 68 over which mate plurality of upper cavity defining sub-portions. For purposes of the illustration of FIGS. 8-11 and 13, selected upper cavity defining sub-portions (such as notably shown at 32 in FIGS. 3-7 and for assisting in forming the upper surface of the first shot supporting tray) are removed from FIGS. 8 et seq., with attention being focused to a variation in second shot flap formation sub-components which are referenced by selected displaceable portions 70 and 72 which are integrated into the upper mold sub-assembly and which are associated with the formation of a single flap. As further previously described, any arrangement of configuration of material feed channels (not shown) can be provided for facilitating communication of the first and second shot injection molded materials successively into the feed zones for respectively creating the first shot harder tray and second shot softer/hinged flap(s).

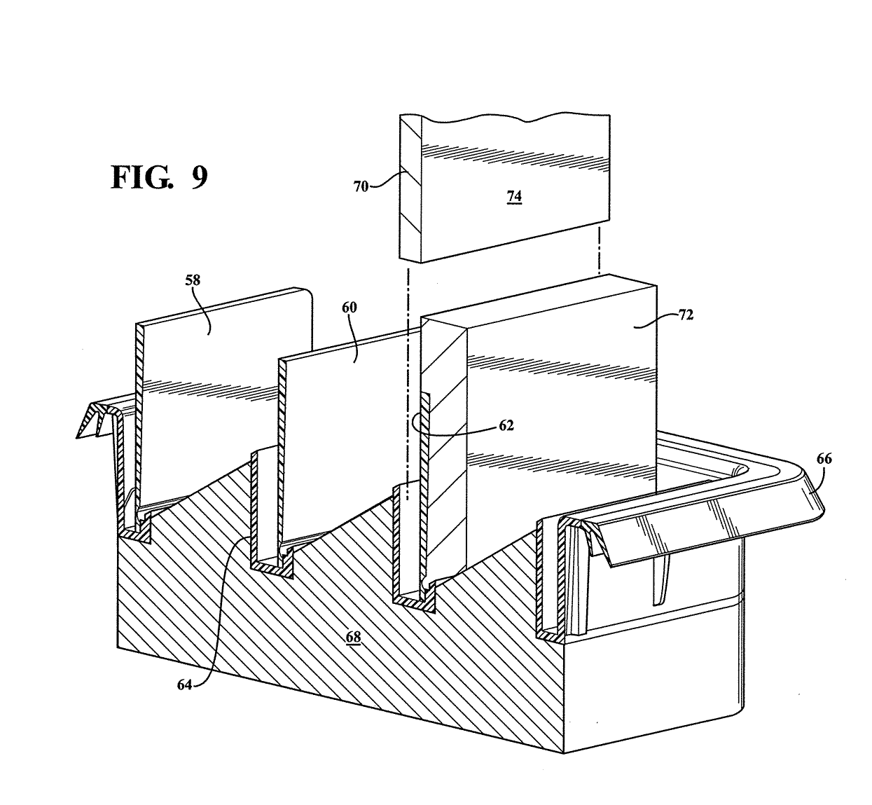

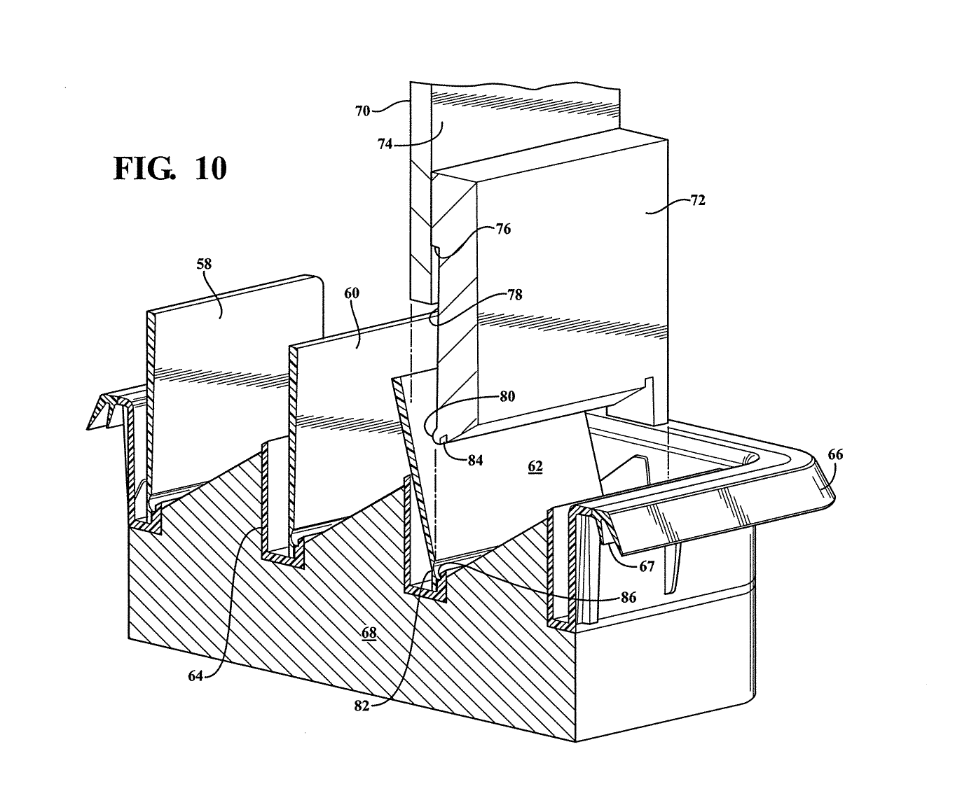

In particular, the upper illustrated flap defining components 70 and 72 each exhibit overlapping and width extending structure for forming a selected flap (see as represented as associated with flap 62) therebetween. The mold component 70 exhibits a smooth inner, typically steel, surface 74 (see FIG. 9), whereas the opposing mating surface of the mold component 72 (see FIG. 10) includes uppermost underside edge surface 76 (corresponding to the end of the flap), length extending surface 78, and, inner/bottom-most curved or convex surface 80 (similar in respects to the bottom extending profile 47 depicted in FIGS. 6-7). As with the previous embodiment, these flap defining surfaces can be steel surfaced to assist in the correct formation and finish to the flap portion formed thereby.

In the illustration of FIG. 8, the illustrated pair of upper mold components 70/72 associated with the formation of the selected indicated flap 62 (other identically configured pairs of mating upper mold components again not being shown along with the other alternating upper mold portions not unlike those at 32 in FIG. 3) are shown in a closed mold arrangement with the lower mold half 68 and so that the two stage (or two shot) injection molding operation can be performed in order to create the tray and flaps associated with the ventilation module. As will be described in additional detail, the configuration of the upper mold sub-assembly, in particular the ability to form the flaps and retract the upper flap defining components 70/72 prior to opening of the mold, provides advantages to the formation of the finished ventilation tray not present in the prior art.

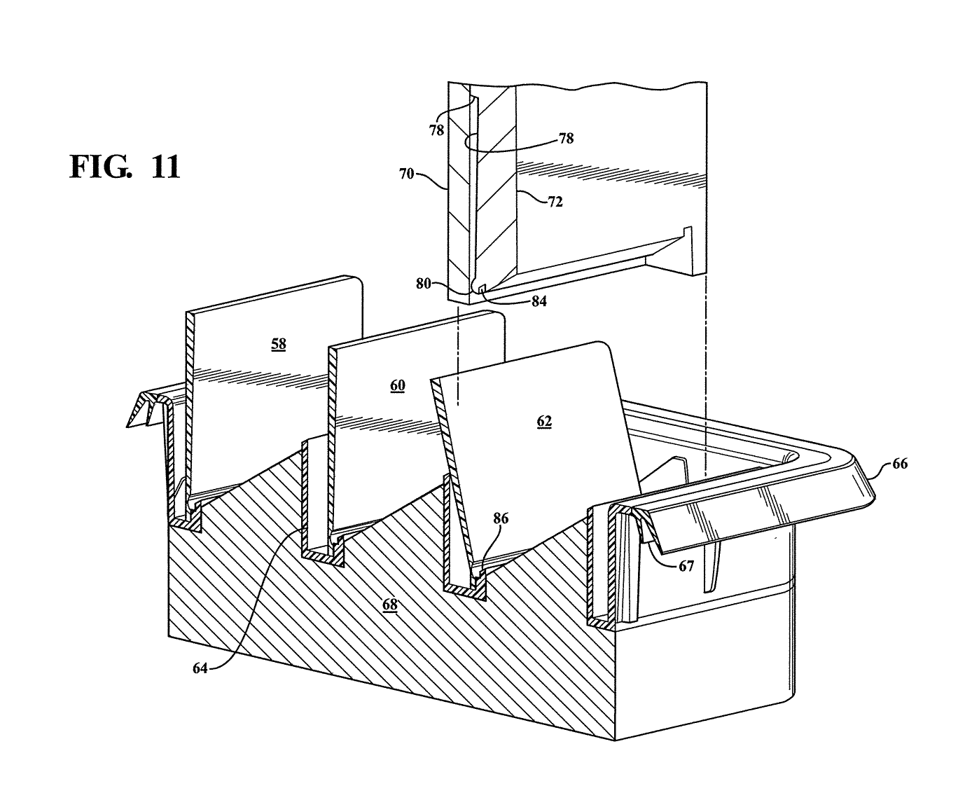

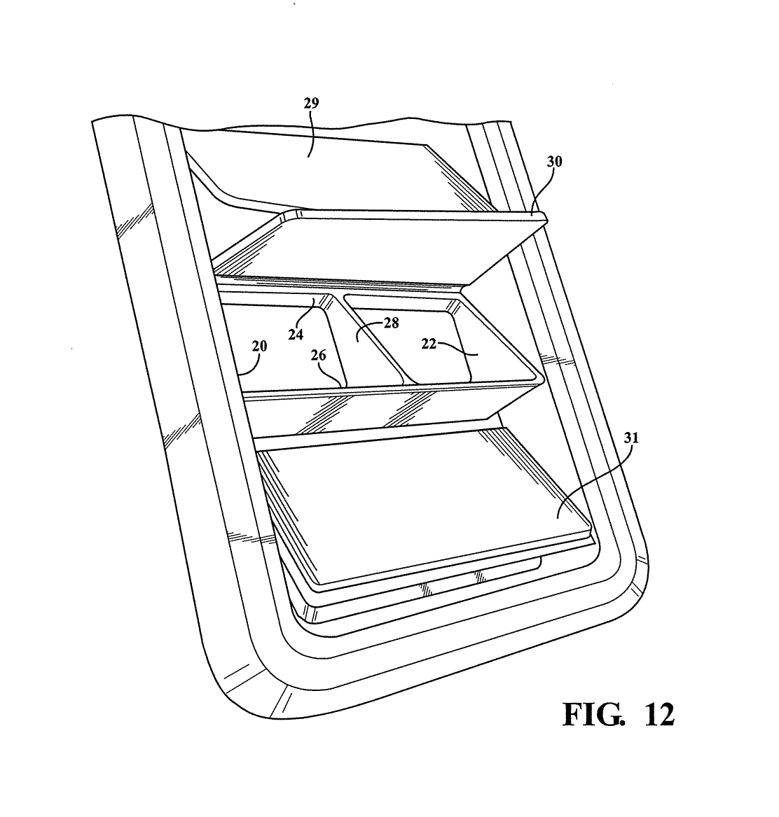

FIG. 9 is a succeeding cutaway illustration to FIG. 8 and depicting an alternate retraction protocol (to that described in FIGS. 3-7) in which each of a plurality of first upper mold sub-portions, again at 70, are first retracted following formation of each of the second shot softer flaps 58, 60 and 62. Following that, and referring to succeeding cutaway illustrations of FIGS. 10-11, each of the further plurality of second upper mold sub-portions 72 are subsequently upwardly retracted, and by so doing release (allow to pop clear) and fully reveal each second shot flap 58-62.

The configuration and arrangement of the bottom edge convex detail 80 (again FIG. 10) of the second upper mold sub-portions 72 impart a concave hinge profile, see at 82, to each flap 58-62, proximate their joining locations with the first shot formed tray 64. Also depicted in each of FIGS. 10-11 is an underside notch 84 formed along the bottom most extending edge of the vertically displaceable upper mold sub-portion 72 and which, in the closed position, seats a likewise width extending upper protuberance or nub 86 associated with an interface location associated with the harder tray 64 and the lower supporting mold component 68, this preventing any undesirable flow through of second shot material in order to prevent mis-forming of the flap configuration and to ensure that the concave profile 82 created near the bottom edge of the flap and interfacing/molded over inner supporting surface of the tray provides for effective and long-life pivoting of the flaps between the open (exhaust) and closed (sealed positions).

Finally, FIG. 13 is an illustration similar to FIG. 8 and illustrating a non-limiting example of an actuating mechanism, this most generally depicting side supporting linkage arms 86 and 88 associated with the upper mold assembly, and for respectively coordinating any timed closure and re-opening/release of the upper mold sub-portions 70 and 72 associated with the upper mold during the second shot formation of multiple softer material flaps. Without limitation, the additional upper mold defining components (notably again include a further alternating plurality of upper mold portions similar in configuration to that shown at 32 in FIG. 3) can be incorporated into the linkage configuration shown and in order to establish a repetitive process for producing a given ventilation tray in volume according to any specifications.

As previously described, advantages of the present assembly include the ability to mold the flaps in an extending (open) direction away from the lower mold subassembly 68 (such eliminating the need for a laterally insertable separation plate as in Dietz 6,132,308 prior to opening the mold). Rather, the present design allows the steel flap forming surfaces, in particular at 74 associated with the back side of the flap and shown in FIGS. 9-11, to travel in the retraction direction of the upper mold subassembly (tool).

Having described my invention, other and additional preferred embodiments will become apparent to those skilled in the art to which it pertains, and without deviating from the scope of the appended claims. This can include, without limitation, repositioning the hinge to any other location not limited to an opposite side of each flap.

We claim:

1. A ventilation module integrated into a vehicle, comprising:
a housing defining an open interior and which is adapted to secure to a location of the vehicle in order to communicate an exterior with a passenger compartment interior;
a flap hingedly secured along a selected edge in extending fashion across said open interior of said housing, said flap further including first and second side edges and an interconnecting top extending edge which are configured to engage support locations configured along said housing in proximity to said open interior;
said flaps being configured to seal against said housing in a first direction to prevent the admittance or backflow of dirty air from the exterior into the interior compartment, said flaps opening in a second direction in response to a positive air pressure condition created within the passenger compartment and in order to vent to the exterior the excess air pressure until reclosing upon achieving an air equilibrium condition.

2. The ventilation module as described in claim 1, said housing having a generally rectangular shape with an outer perimeter gasket which is secured to an outer perimeter projecting ledge which defines a sealing surface for securing said housing to the vehicle.

3. The ventilation module as described in claim 1, said housing further comprising a rigid first shot injection molded thermoplastic.

4. The ventilation module as described in claim 3, said flaps further comprising a second shot softer injection molded plastic.

5. The ventilation module as described in claim 1, said at least one flap further comprising a plurality of three valve flaps resistively engaged to said housing along bottom edges thereof and in order to seal first, second and third subset open interiors.

6. A mold assembly for producing a ventilation module, comprising:
a lower mold subassembly having a cavity configuration corresponding to an underside profile of a tray portion of the module; and
an upper mold assembly comprising a plurality of sub-components which are collectively seated upon said lower mold subassembly in a mold closing configuration;
an interior configuration established between said mating mold subassemblies corresponding to a negative of the tray and flaps corresponding to the module to be produced, material feed channels extending to communicating locations of the interior configuration and in order to produce the tray in a first shot injection molding operation, following which at least one flap is formed in a second shot injection molding operation so that the flaps are each hingedly secured along selected edges of the tray in extending fashion across an open interior of the housing.

7. The mold assembly as described in claim 6, further comprising a subset plurality of said upper mold sub-components further comprising a first upper mold sub-component exhibiting a smooth inner surface, an opposing mating surface of a second upper mold sub-component including an uppermost underside edge surface corresponding to an end of a second shot molded flap, a length extending surface and an inner/bottom-most curved surface.

8. The mold assembly as described in claim 7, said second selected upper mold sub-component further comprising an underside notch formed along a bottom most extending edge and which, in the closed position, seats a likewise width extending upper protuberance or nub associated with an interface location of the first shot formed tray and the lower supporting mold component, preventing undesirable flow through of second shot material and in order to prevent mis-forming of the flap configuration and to ensure that the concave profile created near a bottom edge of the flap and interfacing/molded over inner supporting surface of the tray provides for effective and long-life pivoting of the flaps between the open (exhaust) and closed (sealed positions).

9. The mold assembly as described in claim 6, further comprising an actuating mechanism including side supporting linkage arms associated with the upper mold assembly, and for respectively coordinating timed closure and re-opening/release of the upper mold sub-portions relative the lower mold during the second shot formation of multiple softer material flaps.
